(19) United States
(12) Patent Application Publication
(10) Pub. No.: US 2019/0385169 A1
(43) Pub. Date: Dec. 19, 2019

(54) PAYMENT VERIFICATION BASED ON IDENTIFICATION MATERIALS

(71) Applicant: INTERNATIONAL BUSINESS MACHINES CORPORATION, ARMONK, NY (US)

(72) Inventors: YUN XIANG, Beijing (CN); Li Na Wang, Beijing (CN); YUAN HU, Beijing (CN); Xi Quan, BEIJING (CN); Kun Song, BEIJING (CN)

(21) Appl. No.: 16/008,121

(22) Filed: Jun. 14, 2018

(51) Int. Cl. G06Q 20/40

(52) U.S. Cl. CPC G06Q 20/4014

(57) ABSTRACT

A computer-implemented method, a computer system and a computer program product are proposed. According to the method, a payment completion material is acquired. Then an identification material is determined. After that, a payment completion page is generated based on the identification material and the payment completion material.

### BACKGROUND

The present disclosure relates to payments in network circumstances, and more specifically, to payment verification based on identification materials.

Nowadays, with the rapid developing of internet, payments through internet, especially using mobile device are widely used, which brings great conveniences to people's life. However, a concern about safety of payments arises accordingly.

### SUMMARY

This Summary is provided to introduce processing payment completion material that are further described herein in the Detailed Description. This Summary is not intended to identify key factors or essential features of the claimed subject matter, nor is it intended to be used to limit the scope of the claimed subject matter.

According to one embodiment of the present invention, there is provided a computer-implemented method. According to the method, a payment completion material is acquired. Then an identification material is determined. After that, a payment completion page is generated based on the identification material and the payment completion material.

In another aspect, a computer-implemented system is disclosed. The system may include a computer processor coupled to a computer-readable memory unit, said memory unit comprising instructions that when executed by the computer processor implements the above method.

In yet another aspect, a computer program product is disclosed. The computer program product comprises a computer readable storage medium having program instructions embodied therewith. When executed on one or more processors, the instructions may cause the one or more processors to perform the above method.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system which is applicable to implement the embodiments of the present invention.

FIG. 2 shows a schematic diagram of a payment completion material processing system in accordance with embodiments of the present disclosure.

FIG. 3 shows an example of payment completion material in accordance with embodiments of the present disclosure.

FIG. 4A shows an example of identification material in accordance with embodiments of the present disclosure.

FIG. 4B shows an example of payment completion page in accordance with embodiments of the present disclosure.

FIG. 5A shows another example of identification material in accordance with embodiments of the present disclosure.

FIG. 5B shows another example of payment completion page in accordance with embodiments of the present disclosure.

FIG. 6A shows yet another example of payment completion page in accordance with embodiments of the present disclosure.

FIG. 6B shows yet another example of payment completion page in accordance with embodiments of the present disclosure.

FIG. 6C shows yet another example of payment completion page in accordance with embodiments of the present disclosure.

FIG. 6D shows yet another example of payment completion page in accordance with embodiments of the present disclosure.

FIG. 6E shows yet another example of payment completion page in accordance with embodiments of the present disclosure.

FIG. 7 shows a flowchart of a method for processing payment completion material in accordance with embodiments of the present disclosure.

FIG. 8 depicts a cloud computing environment according to an embodiment of the present invention.

FIG. 9 depicts abstraction model layers according to an embodiment of the present invention.

### DETAILED DESCRIPTION

Some preferable embodiments will be described in more detail with reference to the accompanying drawings, in which the preferable embodiments of the present disclosure have been illustrated. However, the present disclosure may be implemented in various manners, and thus should not be construed to be limited to the embodiments disclosed herein.

References in the specification to “one embodiment”, “an embodiment”, “an example embodiment”, “certain embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of those of ordinary skill in the art to affect such feature, structure, or characteristic in connection with other embodiments whether or not explicitly described.

The present invention may be a system, a method, and/or a computer program product at any possible technical detail level of integration. The computer program product may include a computer readable storage medium (or media) having computer readable program instructions thereon for causing a processor to carry out aspects of the present invention.

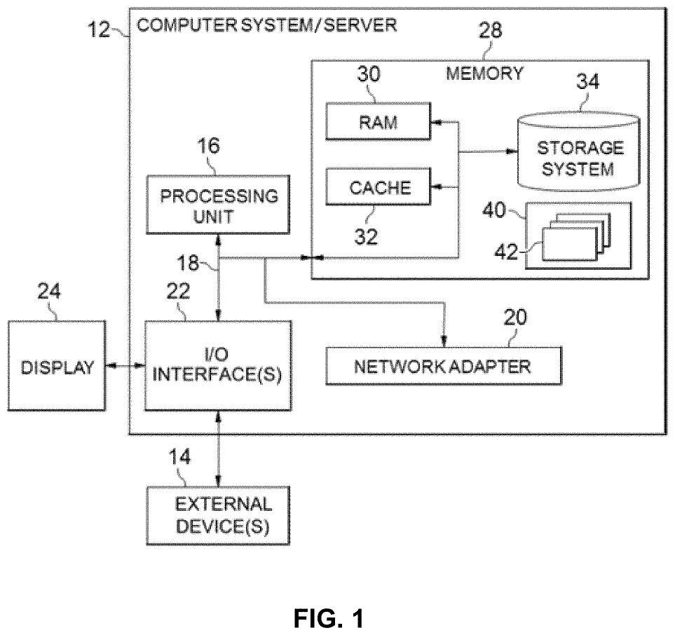

Referring now to FIG. 1, in which an exemplary computer system/server 12 which is applicable to implement the embodiments of the present invention is shown. FIG. 1 is also adapted to depict an illustrative example of a portable electronic device such as a communication device which is applicable to implement the embodiments of the present invention. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing Units 17, a system memory 28, and a bus 18 that couples various system components including system memory 28 to processor 17.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 may include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication may occur via Input/Output (I/O) interfaces 22. Still yet, computer system/server 12 may communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components may be used in conjunction with computer system/server 12. Examples, include, but are not limited to: microcode, device drivers, redundant processing Units, external disk drive arrays, RAID systems, tape drives, and data archival storage systems, etc.

Conventionally, as mentioned above, developing of internet and mobile internet changes people's life in many aspects, and wide usage of mobile devices, especially smart phones, is one of the significant aspects. With the rapid development of internet and mobile internet, payment, especially face-to-face payment, is used widely in retail industry nowadays. By this way, people now may use smart phones to pay through the internet instead of paying using cashes or credit cards. Undoubtedly this way brings great convenience to users without the need of carrying cashes or even credit cards. However, there are still some limitations. For example, a payee may need to get certain qualification to obtain a device to scan a payer's QR code so as to charge the payer on a safer way of transaction. But, most of small vendors do not have this kind of device, and they just post their QR codes so that the payer may scan their QR codes to complete the payments. After the payer scans the payee's QR code and completes the payment, the payment completion information indicating the payment is completed would be shown on both the payee's and the payer's devices accordingly. However, the payee is usually too busy to check on his/her own device about whether the money has been received, especially at a trading peak at a certain period, so s/he would rather to just take a look at the payment completion information on the payer's device to determine if s/he has received the money. This gives cheaters an opportunity. Some cheaters may make the fake payment completion information to deceive the payee without actually paying the money. The payee may suffer a loss of money, and safety of the payment may be challenged.

In order to, at least partly, solve the above mentioned and other potential problems, according to embodiments of the present disclosure, a new approach for securing payment based on internet is proposed. It shall be understood that the payments using mobile devices are just examples in the present disclosure, and methods, computer systems and computer program products proposed by the present disclosure may be used in a plurality of payments circumstances, including and not limited to, payments using mobile devices, payments using wired devices, payments using fixed devices, etc.

Some definitions are provided for better understanding of embodiments of this disclosure. Hereinafter, “payment completion material” may refer to information or data indicating the payment is completed successfully. “Identification material” may refer to a material combined into or used with a payment completion material, which helps a payee to recognize the payment completion material as true or false. “payment completion page” may refer to a material obtained after combining the payment completion material and the identification material.

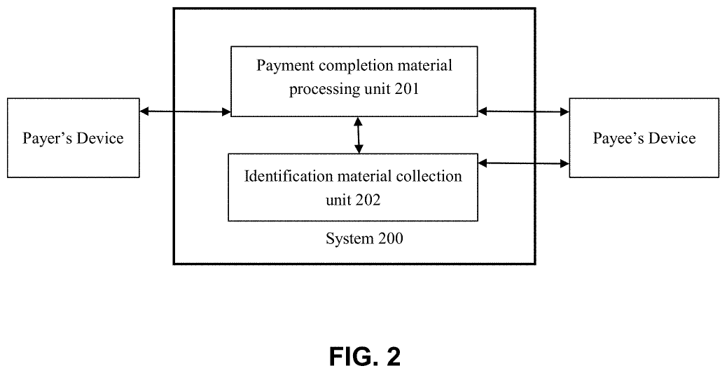

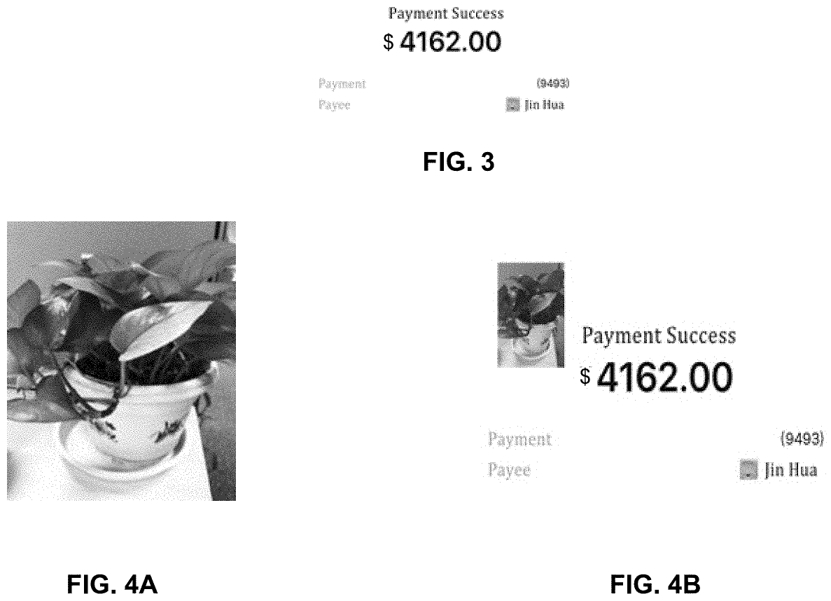

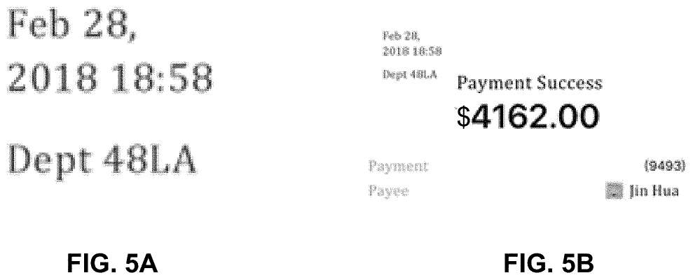

With reference now to FIG. 2, FIG. 2 shows a schematic diagram of a payment completion material processing system 200 in accordance with embodiments of the present disclosure. System 200 can be a server, a cloud server, or any other local or remote device suitable to implement the methods of the present disclosure. System 200 comprises a payment completion material processing unit 201, and an identification material collection unit 202. In one embodiment, the payment completion material processing unit 201 acquires a payment completion material. In certain embodiments, the payment completion material may be generated and sent by a transaction procession unit on a server. Any suitable technology, either currently known or to be developed in future, may be applied to generate the payment completion material. FIG. 3 shows an example of a payment completion material which comprises an amount of the transaction, a symbol of payment completion, a payment sequence number and a payee's account. In some embodiments, the payment completion material is generated based on information related to transaction, such as transaction amount, payer's account, the symbol of successful payment, etc. It's to be known for those skilled in the art that, there would be other forms of payment completion material besides the example material shown in FIG. 4. In some embodiments, the payment completion material processing unit 201 generates the identification material directly. For example, the payment completion material processing unit 201 acquires the information related to a transaction, such as the time of the transaction, the date of the transaction, the location of the transaction, the amount of the transaction, the account of the payer, the account of the payee, etc., to generate the identification material. FIG. 5A shows an example of an identification material generated based on the information related to a transaction. In a further embodiment, the payment completion material processing unit 201 acquires an identification material from the payee or from the identification material collection unit 202 according to a pre-defined rule which would be further described below.

The identification material collection unit 202 stores candidate identification materials, as well as identification material selection rules which determines which identification material to be selected, and identification material presenting rules which determines how the identification material is shown on the payment completion page for each transaction. The candidate identification materials may be in the forms of: text, number, picture, video, voice, etc. In one embodiment, the candidate identification materials may be pre-stored in the identification material collection unit 202. In another embodiment, the candidate identification materials may be uploaded by the payee. In this case, the payee may select the materials which are meaningful and/or easy to be recognized by him/her as the candidate identification materials, and then upload the candidate identification materials to the system 200 or another device storing the candidate identification materials. The candidate identification materials may comprise, such as, a handwritten text of the payee, a voice of the payee, a photo of the payee, etc., as well as other materials composed of texts, numbers, letters, photos, pictures, videos, voices, etc. An identification material to be used may be selected from the candidate identification materials according to an identification material selection rule. In a further embodiment, the payee may define a valid period or times limitation of usage for each or some of the candidate identification materials. In this case, a candidate identification material may be selected only within its valid period or times limitation of usage. FIG. 4A shows an example of an identification material. In FIG. 4A, a photo of a pot plant which the payee is familiar with is shown.

An identification material to be used may be selected from the candidate identification materials according to an identification material selection rule. In one embodiment, the identification material selection/presenting rules may be defined by the system 200 directly. In another embodiment, these rules may be defined by the payee. The rule to be used may be selected from these rules by the system 200 or the payee.

Here are some examples of identification material selection rules and identification material presenting rules. It should be understood for those skilled in the art that many other suitable rules are also adoptable.

Examples of identification material selection rules:

Rule 1: Selecting an identification material from a set of candidate identification materials randomly.

Rule 2: Selecting an identification material from a set of candidate identification materials randomly, wherein the set of identification materials are provided by the payee.

Rule 3: Selecting an identification material from a set of candidate identification materials in a pre-defined order.

Rule 4: Selecting an identification material from a set of candidate identification materials in a pre-defined order, wherein the set of identification materials and/or the pre-defined order are determined by the payee.

Rule 5: Selecting an identification material from a set of candidate identification materials which are still valid.

Rule 6: Selecting identification material as numbers in an ascending/descending order.

Rule7: Selecting identification material as letters in an alphabetic order.

Examples of identification material presenting rules:

Rule 1: Changing the presenting position of an identification material in the payment completion page, furthermore in a pre-defined order, such as in a clockwise order.

Rule 2: For an identification material comprising a video, changing the size of the video in the payment completion page.

Rule 3: For an identification material comprising a voice or a video, change the volume of the voice, furthermore in a pre-defined order.

Rule 4: For an identification material comprising a text, changing the font of the text, furthermore in a pre-defined order.

Rule 5: For an identification material comprising a text or a picture, changing the lightness, the color and/or the size of the identification material, furthermore in a pre-defined order.

Rule 6: For an identification material comprising a picture, rotating the picture, furthermore in pre-defined order, such as in a counter clockwise order.

Rule 7: For an identification material comprising a picture, stitching the picture, furthermore in a pre-defined order, such as the first stitched picture is composed of the first picture and second picture, the second stitched picture is composed of the second picture and third picture, and so on.

In a further embodiment, the payment completion material processing unit 201 combines the acquired/generated identification material and the payment completion material to generate a payment completion page. In some embodiments, after acquiring the identification material to be combined, the payment completion material processing unit 201 combines the acquired identification material and the payment completion material according to current identification material presenting rule to generate the payment completion page. FIGS. 4B and 5B are examples of payment completion pages which combines the identification material shown on FIG. 4A and 5A respectively.

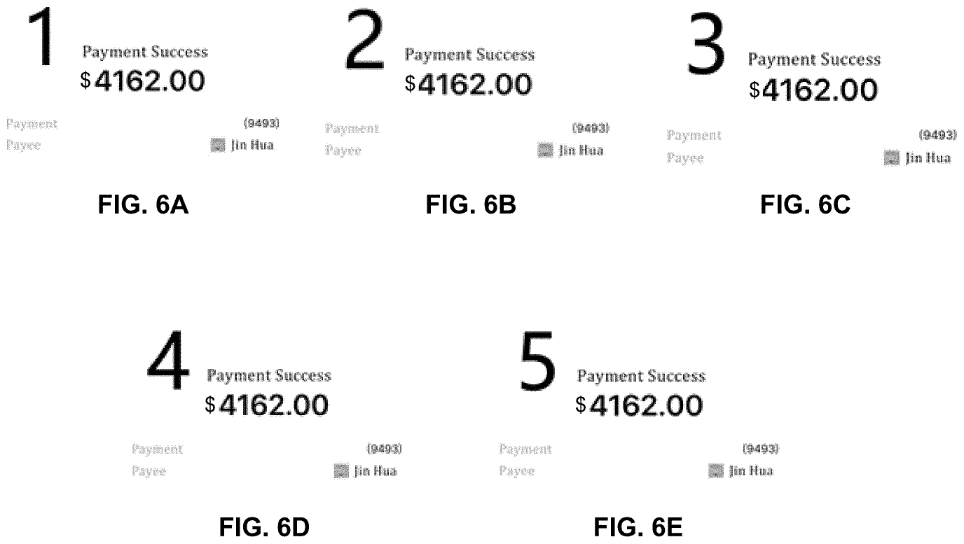

FIG. 6A-6E are several further examples of payment completion pages. As shown on FIG. 6A-6E, corresponding identification material included in each of the payment completion page is number 1-5, and the identification material being used may be changed periodically from 1 to 5, such as per pre-defined period or pre-defined transaction times, or in response to a request from the payee. It would be hard for the cheater to fake the payment completion page as he/she doesn't know what the current identification material is.

In a further embodiment, the payment completion page may be transferred to the payer's device.

In an alternative embodiment, the payer's device may perform payment completion material processing. In this embodiment, the payer's device receives a payment completion material, and then receives an identification material from a server or from the payee's device directly. Then a payment completion page is generated which combines the payment completion material and the identification material. In some embodiment, the identification material may be generated/selected and presented on the payment completion page according to the ways and rules described above.

By this way, even if the payee doesn't have enough time to check the payment completion material on her/his device, the payee may determine whether the payment completion information that the payer shows to her/him is faked by recognizing whether a specific identification material is included in the payment completion information. In a further embodiment, the identification material would be sent to the payee's device at the same time, so the payee may be able to know what the current identification material is. In yet another embodiment, the payment completion page instead of the payment completion material would be transferred to the payee's device too.

One or more identification materials may be used in a transaction. And accordingly, one or more identification material selection/presenting rules may be used in a transaction too. The identification material used in each transaction may be changed periodically, such as per every pre-defined period, every pre-defined transaction times. In a further embodiment, the period or the transaction times for a transaction peak may be different from normal time. In another embodiment, the identification material and/or the identification material selection /presenting rule may be changed in response to a request from the payee.

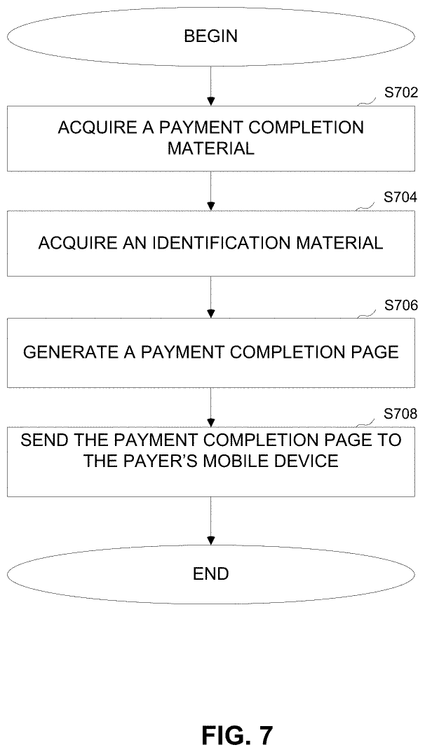

With reference now to FIG. 7, a flowchart of an exemplary method 700 for generating payment completion page according to certain embodiments of the present invention is illustrated. The method 700 may be implemented by the system 200 or a device of a payer. The method 700 starts at block 702 in which a payment completion material is acquired. Then the method goes to step 704, in which an identification material is acquired. The identification material may be generated based on the information related to transaction, or selected from candidate identification materials based on a pre-defined rule described above or from the payee directly. For example, according to the identification material selection rule being used is “Selecting identification material from a set of number [1,2,3,4,5] in the order from 1 to 5”. The identification material may be 1 to 5 for the coming 5 transactions separately. In certain embodiments, the identification material being used may be changed periodically from 1 to 5, such as per pre-defined period or pre-defined transaction times, or in response to a request from a payee. In certain embodiments, the identification material selection rule being used may be changed periodically, such as per pre-defined period or pre-defined transaction number, or in response to a request from the payee.

After acquiring payment completion material and identification material, a payment completion page would be generated according to the current identification material presenting rule in step 706. In this step, the identification material is combined with the payment completion material to generate a payment completion page according to the identification material presenting rule used for this transaction. The identification material presenting rule being used may be changed periodically, such as per pre-defined period or pre-defined transaction times, or in response to a request from a payee. It would be hard for the cheater to fake the payment completion page because he/she doesn't know what the current identification material is.

In addition, the method 700 may go to optional step 708. In step 708, the payment completion page is sent to the payer's mobile device. In an alternative embodiment, the payment completion page is generated on the payer's device since the payer's device may process the payment completion material itself. In this case, step 708 may be omitted. By this way, even if the payee doesn't have enough time to check the payment completion information on her/his side, s/he may determine whether the payment completion page that the payer shows to her/him is faked by checking whether the identification material is presented in the payment completion page. Furthermore, the identification material may be sent to the payee's device. By this way the payee may take a look at his/her device from time to time to know what the current identification material is. Then the payment completion page would be transferred to the payee's device too.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state material of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on- demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

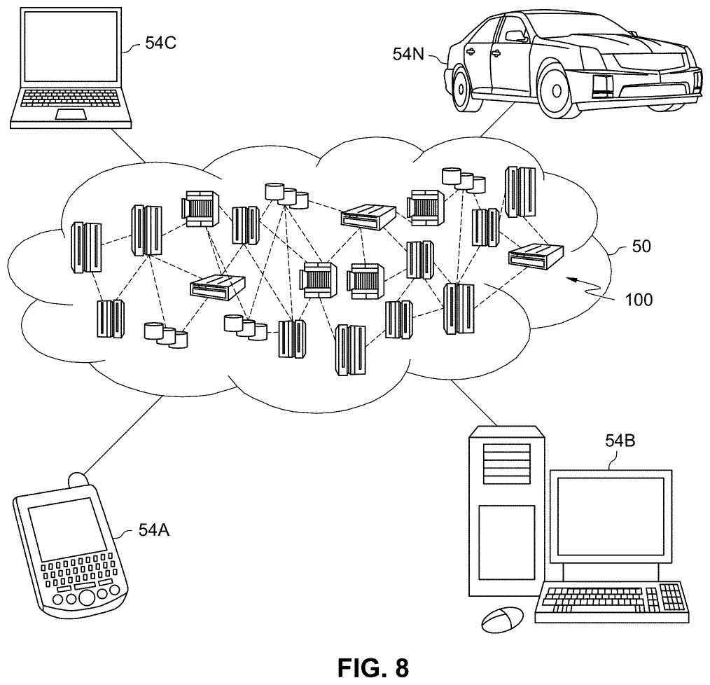

Referring now to FIG. 8, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 100 and cloud computing environment 50 can communicate with any type of computerized device over any type of network and/or network addressable connection (e.g., using a web browser).

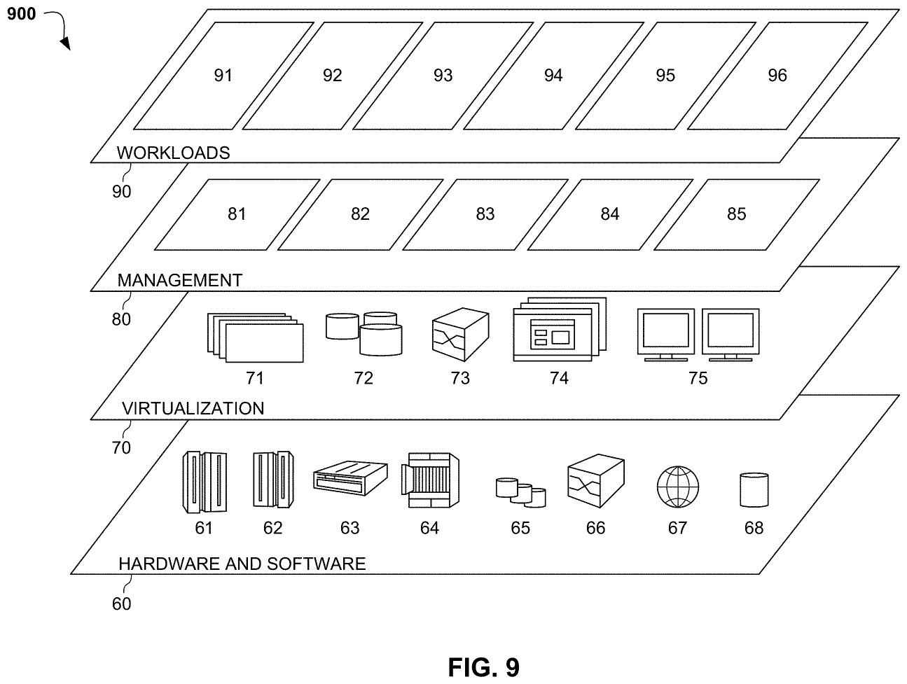

Referring now to FIG. 9, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and payment verification processing 96. Payment verification processing 96 may relate to acquiring a payment completion material determining an identification material and generating a payment completion page based on the identification material and the payment completion material.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for payment verification based on identification materials, the method comprising:
acquiring, by one or more processing units, a payment completion material;
determining, by one or more processing units, an identification material; and
generating, by one or more processing units, a payment completion page based on the identification material and the payment completion material.

2. The method of claim 1, wherein the identification material includes at least one of:
text, picture, video, voice, and number.

3. The method of claim 1, wherein the identification material is determined based on information related to a transaction, the information includes at least one of: time of the transaction, a date of the transaction, a location of the transaction, an amount of the transaction, an account of a payer, and an account of a payee.

4. The method of claim 1, wherein the identification material is provided by a payee.

5. The method of claim 1, wherein determining an identification material further comprises:
determining, by one or more processing units, the identification material from a set of candidate identification materials according to an identification material selection rule.

6. The method of claim 5, wherein the identification material selection rule is changed periodically, after pre-defined transaction times, or in response to a request from a payee.

7. The method of claim 1, wherein generating a payment completion page further comprises:
generating, by one or more processing units, the payment completion page according to an identification material presenting rule.

8. The method of claim 7, wherein the identification material presenting rule is changed periodically, after pre-defined transaction times, or in response to a request from a payee.

9. The method of claim 7, wherein the identification material presenting rule is at least one of:
changing a present position of the identification material in the payment completion page;
changing lightness, color or size of the identification material in the payment completion page; and
rotating the identification material in the payment completion page.

10. A computer system for payment verification based on identification materials, the computer system comprising:
a processor;
a computer-readable memory coupled to the processor, the memory comprising instructions that when executed by the processor perform actions of:
acquiring a payment completion material;
determining an identification material; and
generating a payment completion page based on the identification material and the payment completion material.

11. The computer system of claim 10, wherein the identification material is determined based on information related to a transaction, the information includes at least one of: time of the transaction, a date of the transaction, a location of the transaction, an amount of the transaction, an account of a payer, and an account of a payee.

12. The computer system of claim 10, wherein the identification material is provided by a payee.

13. The computer system of claim 10, wherein determining an identification material further comprises:
determining the identification material from a set of candidate identification materials according to an identification material selection rule, wherein the identification material selection rule is changed periodically, after pre-defined transaction times, or in response to a request from a payee.

14. The computer system of claim 10, wherein generating the payment completion page further comprises:
generating the payment completion page according to an identification material presenting rule.

15. The computer system of claim 14, wherein the identification material presenting rule is changed periodically, after pre-defined transaction times, or in response to a request from a payee.

16. A computer program product for payment verification based on identification materials, the computer program product comprising:
a computer readable storage medium having program instructions stored therein, wherein the program instructions, when executed on a computing device, cause the computing device to:
acquire a payment completion material;
determine an identification material; and
generate a payment completion page based on the identification material and the payment completion material.

17. The computer program product of claim 16, wherein the identification material is determined based on information related to a transaction, the information includes at least one of: time of the transaction, a date of the transaction, a location of the transaction, an amount of the transaction, an account of a payer, and an account of a payee.

18. The computer program product of claim 16, wherein the identification material is provided by a payee.

19. The computer program product of claim 16, wherein determining an identification material further comprises:
determine the identification material from a set of candidate identification materials according to an identification material selection rule, wherein the identification material selection rule is changed periodically, after pre-defined transaction times, or in response to a request from a payee.

20. The computer program product of claim 17, wherein generate a payment completion page further comprises:
generate the payment completion page according to an identification material presenting rule, wherein the identification material presenting rule is changed periodically, after pre-defined transaction times, or in response to a request from the payee.
